(19) United States
(12) Patent Application Publication
(10) Pub. No.: US 2024/0012604 A1
(43) Pub. Date: Jan. 11, 2024

(54) VIRTUAL WORKSPACE VIEWPORT FOLLOWING IN COLLABORATION SYSTEMS

(71) Applicant: Haworth, Inc., Holland, MI (US)

(72) Inventor: Rupen CHANDA, Austin, TX (US)

(73) Assignee: Haworth, Inc., Holland, MI (US)

(21) Appl. No.: 18/219,551

(22) Filed: Jul. 7, 2023

Related U.S. Application Data
(60) Provisional application No. 63/359,709, filed on Jul. 8, 2022.
(60) Provisional application No. 63/459,223, filed on Apr. 13, 2023.

(51) Int. Cl. G06F 3/14

(52) U.S. Cl. CPC G06F 3/1454

(57) ABSTRACT

Systems and methods of a server node are provided for sending data identifying digital assets in a workspace. The method includes receiving data from a server node, the data identifies digital assets in the workspace. The method includes identifying first digital assets in the workspace that have locations outside mapped display coordinates of a display linked to the follower node. The method includes sending to a follower node, the received data identifying digital assets in the workspace and the data identifying the first digital assets. The data sent to the follower node allows display of the digital assets in the workspace with locations mapping inside the mapped display coordinates of the display linked to the follower node and prevents display of the first identified digital assets with locations outside mapped display coordinates of the display linked to the follower node.

### PRIORITY APPLICATION

This application claims the benefit of U.S. Provisional Patent Application No. 63/359,709 (Attorney Docket No. HAWT 1043-1), entitled, “Virtual Workspace Viewport Following in Collaboration Systems,” filed on Jul. 8, 2022, and also claims benefit of U.S. Provisional Patent Application No. 63/459,223 (Attorney Docket No. HAWT 1047-1), entitled, “Method and System for Summoning Adaptive Toolbar Items and Digital Assets Associated Therewith on a Large Format Screen Within a Digital Collaboration Environment”, filed on Apr. 13, 2023, both of the above-listed applications are incorporated herein by reference.

### FIELD OF INVENTION

The present technology relates to collaboration systems that enable users to collaborate in a virtual workspace in a collaboration session. More specifically, the technology relates to collaboration systems that facilitate multiple simultaneous users in accessing global workspace data using devices with different display sizes.

### BACKGROUND

Collaboration systems are used in a variety of environments to allow users to contribute and participate in content generation and review. Users of collaboration systems can join collaboration sessions from remote locations around the globe. A participant in a collaboration session can share content such as digital assets with other participants in the collaboration session, using a digital whiteboard. The digital assets can be documents such as word processor files, spreadsheets, slide decks, notes, program code, etc. Digital assets can also be graphical objects such as images, videos, line drawings, annotations, etc. Digital displays are often used for interactive presentations and other purposes in a manner analogous to whiteboards. In many scenarios, one of the participants in the collaboration session shares content with other participants in the meeting. This participant can share the content using a large format display and one or more other participants may view the shared content on devices with small format display. A large difference in display sizes can cause issues in proper viewing of the content by participants of a collaboration session. For example, the content may appear as very small on displays of small format devices which can make it very difficult to review by the participants.

An opportunity arises to provide a technique to automatically adjust the content on respective displays of devices with different display sizes.

### SUMMARY

A system and method for operating a server node are disclosed. The method of a server node includes sending data identifying digital assets in a workspace. The method includes receiving, at the server node and from a leader node, data identifying digital assets in the workspace. The method includes identifying, by the server node and from the received data, data identifying first digital assets from the digital assets. The first digital assets have locations outside mapped display coordinates of a display linked to a follower node following the leader node. The method includes sending, to the follower node, the received data identifying the digital assets in the workspace and the data identifying the first digital assets. The data sent to the follower node allows display, on the display linked to the follower node, of only digital assets in the workspace with locations mapping inside the mapped display coordinates of the display linked to the follower node. The date sent to the follower node prevents display of the first digital assets with locations outside mapped display coordinates of the display linked to the follower node.

A size of a display linked to the leader node is at least four times larger than a size of the display linked to the follower node. Larger display sizes linked to the leader node can be used, e.g., eight times, ten times or twelve times larger than the size of the display linked to the follower node.

The leader node can be used by a leader participant presenting collaboration data to a follower participant using the follower node.

The data sent to the follower node, allows a reduction in a size of the displayed digital assets, when displaying the digital assets on the display linked to the follower node. The reduction in the size of the digital assets can reduce the size of the digital assets by ½ times (i.e., one half)) the size of the digital assets as displayed on a display linked to the leader node. Further reduction in the size of digital assets can be performed, e.g., the reduction in the size of the digital assets can reduce the size of the digital assets by ¼ times (i.e., one fourth) the size of the digital assets as displayed on the display linked to the leader node, or up to 1/10 times (i.e., one tenth) the size of the digital assets as displayed on the display linked to the leader node.

In one implementation, the method includes, generating, by the server node and from the received data identifying the digital assets in the workspace, a reduced set of data by removing the data identifying the first digital assets. The method includes sending, from the server node to the follower node, the reduced set of data. The reduced set of data can identify digital assets in the workspace with locations mapping inside the mapped display coordinates of the display linked to the follower node and the reduced set of data does not include the first digital assets.

In one implementation, the method includes, receiving, at the server node, an update event from the follower node indicating a pan operation in response to an input received at the follower node. The pan operation can move at least a portion of the digital assets on the display linked to the follower node. The method includes, generating, from the received data identifying the digital assets in the workspace, a second reduced set of data by removing data identifying digital assets moved outside of the mapped display coordinates of the display linked to the follower node and including one or more of the first digital assets that are inside of the coordinates of the display linked to the follower node as a result of the update event. The method includes, sending, from the server node and to the follower node, the second reduced set of data. The second reduced set of data identifies digital assets in the workspace with locations mapping inside the mapped display coordinates of the display linked to the follower node and the second reduced set of data does not include one or more of the first digital assets that have locations outside mapped display coordinates of the display linked to the follower node as a result of the update event.

The received data, at the server node, can further include toolbar data identifying a toolbar including user interface elements, the toolbar data further identifying a source location and a source dimension of the toolbar as displayed on the display linked the leader node. The method further includes determining a target location and a target dimension of the toolbar for display on the display linked to the follower node. The target location maps inside the mapped display coordinates of the display linked to the follower node and the target location and the target dimension prevent overlap of the toolbar with digital assets displayed in the display linked to the follower node.

A system including one or more processors coupled to memory is provided. The memory is loaded with computer instructions to operate a server node to send data identifying digital assets in a workspace. The instructions, when executed on the one or more processors, implement operations presented in the method described above.

Computer program products which can execute the methods presented above are also described herein (e.g., a non-transitory computer-readable recording medium having a program recorded thereon, wherein, when the program is executed by one or more processors the one or more processors can perform the methods and operations described above).

Other aspects and advantages of the present technology can be seen on review of the drawings, the detailed description, and the claims, which follow.

### BRIEF DESCRIPTION OF THE DRAWINGS

The technology is described with respect to specific embodiments thereof, and reference will be made to the drawings, which are not drawn to scale, described below.

FIGS. 1 and 2 illustrate example aspects of a system implementing automatic adjustment of content on displays of computing devices with different display sizes in a collaboration environment.

FIG. 3 presents an example in which a follower uses a mobile device with a small format display to pan and view content shared by a leader using a large format digital display.

FIGS. 4A and 4B present another example in which a follower uses a mobile device with a small format display to follow a leader and automatically view content on the workspace near a touch point on the large format digital display of the leader.

FIG. 4C presents an example in which toolbars are automatically adjusted on the display of a mobile device of a follower who is viewing content on the small format display of the mobile device shared by a leader using a large format display.

FIGS. 5A, 5B and 5C present an example in which a follower uses a large format display to view content shared by a leader using a mobile device with a small format display.

FIG. 6 presents a computer system that implements the automatic adjustment of content on displays of computing devices with different display sizes, during a collaboration session.

### DETAILED DESCRIPTION

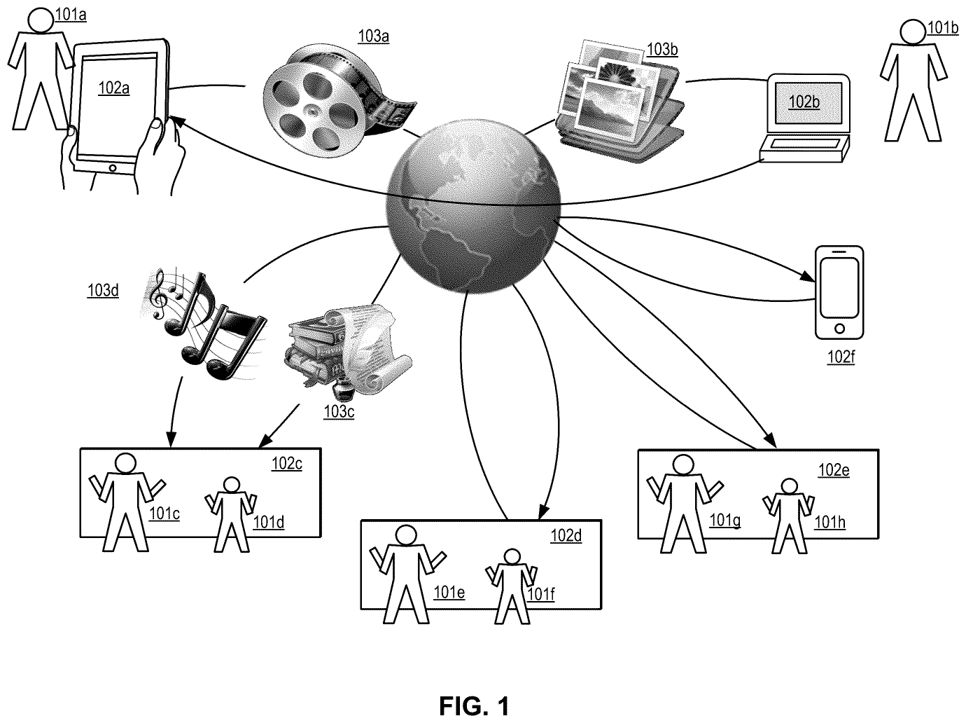

A detailed description of embodiments of the present technology is provided with reference to FIGS. 1-6.

The following description is presented to enable a person skilled in the art to make and use the technology and is provided in the context of a particular application and its requirements. Various modifications to the disclosed embodiments will be readily apparent to those skilled in the art, and the general principles defined herein may be applied to other embodiments and applications without departing from the spirit and scope of the present technology. Thus, the present technology is not intended to be limited to the embodiments shown, but is to be accorded the widest scope consistent with the principles and features disclosed herein.

### INTRODUCTION

Collaboration systems are used in a variety of environments to allow users to contribute and participate in content generation, presentation and review. Users of collaboration systems can join collaboration sessions from remote locations around the world. A participant in a collaboration session can share digital assets or content with other participants in the collaboration session, using a digital whiteboard (also referred as a virtual workspace, a workspace, an online whiteboard, etc.). The digital assets can be documents such as word processor files, spreadsheets, slide decks, notes, program code, etc. Digital assets can also be native or non-native graphical objects such as images, videos, line drawings, annotations, etc. The digital assets can also be websites, webpages, web applications, cloud-based or other types of software applications that execute in a window or in a browser displayed on the workspace.

Digital displays are often used for interactive presentations and other purposes in a manner analogous to whiteboards. In many scenarios, one of the participants in the collaboration session shares content with other participants in the meeting. This participant may be considered as a leader and other participants viewing the content presented by the leader may be considered as followers. The followers view the shared content at remote locations using the displays associated with their respective computing devices. Different participants can use different types of computing devices to participate in a collaboration session. The computing devices can have a variety of display sizes. In one scenario, the leader may be presenting content using a large format display while one or more followers may be viewing that content using mobile devices such as cell phones that have small format displays. The large format displays can have display sizes ranging from a few feet to more than ten feet while mobile devices can have a display size as small as few inches.

The leader of a collaboration session may share content displayed on a viewport of their large format display. The shared content from the viewport of the leader node may not be adequately presented for viewing on display of a small format device (i.e., a computing device with a small format display) of a follower. A size of a large format display can range from a few feet to more than 10 feet and a size of the small format display can be a few inches. The size can be measured diagonally between a top right corner and a bottom left corner (or a top left corner and a bottom right corner) of the display screen of a device. The content displayed on the small format device may become too small if the entire content displayed on the viewport of a large format display is presented on the small format display. In another scenario, the leader can present content using a small format device and the follower may view that content on a large format display. In the above-mentioned collaboration scenarios, the effectiveness of the collaboration session can be reduced if content is not adjusted for presentation according to the display size of client devices. The technology disclosed can automatically adjust the size of content on displays of computing devices of followers when the followers use computing devices with a large difference in display size with respect to the size of the display on which the leader is presenting the content. The technology disclosed can automatically prevent display of some content shared by a leader using a large format display when displaying content on a small format device of a follower. This prevention of display of some content allows relevant content from the viewport of the leader node (i.e., the computing device used by the leader of the collaboration session) to be presented on a small format device in a reasonable size such that the content is easily viewable by the follower.

The technology disclosed is related to automatic adjustment of content displayed on displays of various sizes used by participants in a collaboration session. In particular, the technology disclosed adjusts the size and/or the amount of content displayed on the display of a computing device used by a follower when the display size of the follower node has a large difference in size with respect to the display size of the leader node. For example, the technology disclosed enables a follower to view content, shared by the leader, on a small format display of a mobile device in an efficient manner when the content is shared by the leader using a large format digital display. The follower can pan and zoom to view content shared by the leader. Similarly, the technology disclosed also enables the follower to efficiently view the content on a large format display when the content is shared by the leader using a mobile device with a small format display.

Some key elements of the collaboration system are presented below, followed by further details of the technology disclosed.

### Virtual Workspace

In order to support an unlimited amount of spatial information for a given collaboration session, the technology disclosed provides a way to organize a virtual space termed the “workspace”. The workspace can be characterized by a multi-dimensional and in some cases two-dimensional plane with essentially unlimited extent in one or more dimensions for example, in such a way that new content can be added to the space. The content can be arranged and rearranged in the space, and a user can navigate from one part of the space to another.

Digital assets (or objects), as described above in more detail, are arranged on the virtual workspace (or shared virtual workspace). Their locations in the workspace are important for performing various types of interactions (e.g., editing, deleting, re-sizing, etc.) and gestures. One or more digital displays in the collaboration session can display a portion of the workspace, where locations on the display are mapped to locations in the workspace. The digital assets can be arranged in canvases (also referred to as sections or containers). Multiple canvases can be created in a workspace.

The technology disclosed provides a way to organize digital assets in a virtual space termed as the workspace (or virtual workspace), which can, for example, be characterized by a 2-dimensional plane (along X-axis and Y-axis) with essentially unlimited extent in one or both dimensions, for example. The workspace is organized in such a way that new content such as digital assets can be added to the space, the content can be arranged and rearranged in the space, a user can navigate from one part of the space to another, and a user can easily find desired content (such as digital assets) in the space. The technology disclosed can also organize content on a 3-dimensional workspace (along X-axis, Y-axis, and Z-axis).

### Viewport

One or more digital displays in the collaboration session can display a portion of the workspace, where locations on the display are mapped to locations in the workspace. A mapped area, also known as a viewport within the workspace is rendered on a physical screen space. Because the entire workspace is addressable using coordinates of locations, any portion of the workspace that a user may be viewing itself has a location, width, and height in coordinate space. The concept of a portion of a workspace can be referred to as a “viewport”. The coordinates of the viewport are mapped to the coordinates of the screen space. The coordinates of the viewport can be changed which can change the objects contained within the viewport, and the change would be rendered on the screen space of the display client. Details of workspace and viewport are presented in our U.S. application Ser. No. 15/791,351 (Atty. Docket No. HAWT 1025-1), entitled, “Virtual Workspace Including Shared Viewport Markers in a Collaboration System,” filed Oct. 23, 2017, which is incorporated by reference and fully set forth herein. Participants in a collaboration session can use digital displays of various sizes ranging from large format displays of sizes five feet or more and small format devices that have display sizes of a few inches. One participant of a collaboration session may share content (or a viewport) from their large format display, wherein the shared content or viewport may not be adequately presented for viewing on the small format device of another user in the same collaboration session. The technology disclosed can automatically adjust the zoom sizes of the various display devices so that content is displayed at an appropriate zoom level. Further, the technology disclosed includes the logic to automatically select an appropriate portion of the content from the workspace to display on a device with a small format display. Even if the content is displayed in a smaller size, the devices with small format displays may not have enough display area. This may cause too much reduction in size of content on a device with small format display causing issues in review and analysis of content.

### Spatial Event Map

Participants of the collaboration session can work on the workspace (or virtual workspace) that can extend in two dimensions (along x and y coordinates) or three dimensions (along x, y, z coordinates). The size of the workspace can be extended along any dimension as desired and therefore can considered as an “unlimited workspace”. The technology disclosed includes data structures and logic to track how people (or users) and devices interact with the workspace over time. The technology disclosed includes a so-called “spatial event map” (SEM) to track interaction of participants with the workspace (and the digital assets placed on the workspace) over time. The spatial event map contains information needed to define digital assets and events in a workspace. It is useful to consider the technology from the point of view of space, events, maps of events in the space, and access to the space by multiple users, including multiple simultaneous users. The spatial event map can be considered (or represent) a sharable container of digital assets that can be shared with other users. The spatial event map includes location data of the digital assets in a two-dimensional or a three-dimensional space. The technology disclosed uses the location data and other information related to the digital assets (such as the type of digital asset, shape, color, etc.) to display digital assets on the digital display linked to computing devices used by the participants of the collaboration session.

A spatial event map contains content in the workspace for a given collaboration session. The spatial event map defines arrangement of digital assets on the workspace. Their locations in the workspace are important for performing gestures. The spatial event map contains information needed to define digital assets, their locations, and events in the workspace. A spatial events map system, maps portions of a workspace to a digital display e.g., a touch enabled display. Details of workspace and spatial event map are presented in our U.S. application Ser. No. 14/090,830 (Atty. Docket No. HAWT 1011-2), entitled, “Collaboration System Including a Spatial Event Map,” filed on Nov. 26, 2013, now issued as U.S. Pat. No. 10,304,037, which is incorporated by reference and fully set forth herein.

The information related to the display of digital assets on a display of a client node (i.e., a computing device used by a participant to participate in the collaboration session) can be included in the spatial event map. For example, the spatial event map can include a data structure that can store the display sizes of different client nodes (or client devices or computing devices) participating the collaboration session. The spatial event map can include information about the current zoom-levels at the displays of client nodes participating in the collaboration session. The spatial event map can also include information about the current status of each participant in collaboration session. For example, the current status can indicate whether the participant is participating in the collaboration session as a leader or as a follower. The status of a participant can change during a collaboration session as a follower can become a leader and a leader can become a follower. The collaboration server stores the current status of a participant in the spatial event map. Client nodes can send update events to the server node (or collaboration server) including any updates to the zoom-level, current status of the participant, etc. The server node can then update the spatial event map at all client nodes participating in the collaboration session.

The client nodes include logic to use the information in the spatial event map to automatically adjust display of content on the display attached to computing devices used by participants. This adjustment in display of content can be performed when a follower participant is using a computing device that has display size with a large difference in size with respect to the size of the display of the computing device used by the leader participant (or leading participant). For example, the leader may be using a large format digital display with a display size of several feet while the follower may be using a mobile computing device with a small format display having a display size of a few inches. In some scenarios, the leader may be using a computing device with a small format display while the follower may be using a large format digital display.

### Events

Interactions with the workspace (or virtual workspace) can be handled as events. People, via tangible user interface devices, and systems can interact with the workspace. Events have data that can define or point to a target digital asset to be displayed on a physical display, and an action as creation, modification, movement within the workspace and deletion of a target digital asset, and metadata associated with them. Metadata can include information such as originator, date, time, location in the workspace, event type, security information, and other metadata. Events can also be generated when gestures are performed by a participant. For example, a participant can draw a circle around several digital assets. The server includes the logic to receive an event including the gesture information. The server can use that information in the event to perform an operation e.g., the server can group the digital assets placed inside the circle. The server can also initiate one or more workflows in response to an event indicating a gesture. For example, when a user or a participant draws a line passing through several digital assets, the server can attach copies of these digital assets to an email and send the email to participants of the collaboration session.

The movement and editing of the digital assets can generate an update event related to a particular digital asset of the digital assets. A leader or a presenter, using a leader node (also referred to as a client node), presents or shares content with other participants (also referred to as follower). The leader can pan to display different content in the viewport to the workspace. A viewport update or viewport change event can be generated in response to the pan operation. The server node includes logic to send the event data (such as viewport update event) to the follower nodes (i.e., client nodes used by participants following the leader) so that following participants follow the viewport of the leader and are able to view the content shared by the leader. The spatial event map (SEM), received at respective client nodes, is updated to identify the update event and to allow display of one or more digital assets at an identified location in the workspace in respective display spaces of respective client nodes. The identified location of the particular digital asset can be received by the server node in an input event from a client node. Further details of the leader-follower technology are presented in our U.S. application Ser. No. 15/147,576 (Atty. Docket No. HAWT 1019-2A), entitled, “Virtual Workspace Viewport Following in Collaboration Systems,” filed on May 5, 2016, now issued as U.S. Pat. No. 10,802,783, which is incorporated by reference and fully set forth herein.

Tracking events in a workspace enables the collaboration system to not only present the spatial events in a workspace in its current state, but to share it with multiple users on multiple displays with different display sizes. Also, the spatial event map can have a reasonable size in terms of the amount of data needed, while also defining an unbounded workspace. Further details of the technology disclosed are presented below with reference to FIGS. 1 to 6.

### Environment

FIG. 1 illustrates example aspects of a collaboration environment. In the example, a plurality of users 101a, 101b, 101c, 101d, 101e, 101f, 101g and 101h (collectively 101) may desire to collaborate with each other when presenting and reviewing various types of content including digital assets. Examples of digital assets include documents, images, videos, program code, user interface designs and/or web applications or websites. The plurality of users 101 may collaborate in the creation, review, editing and/or curation of digital assets such as complex images, music, video, documents, and/or other media, all generally designated in FIG. 1 as 103a, 103b, 103c and 103d (collectively 103). The participants or users in the illustrated example use a variety of computing devices configured as electronic network nodes, in order to collaborate with each other, for example a tablet 102a, a personal computer (PC) 102b, many large format displays 102c, 102d, 102e and one or more mobile computing devices 102f with small format displays. These devices 102a, 102b, 102c, 102d, 102e and 102f are collectively referred to as devices 102. The participants (or users) can also use one or more mobile computing devices and/or tablets with small format displays to collaborate. In the illustrated example, the large format displays 102c, 102d and 102e can accommodate more than one user, e.g., users 101c and 101d, users 101e and 101f, and users 101g and 101h, respectively. A large format display such as 102c is also sometimes referred to herein as a “wall” or a “digital display wall.”

In one implementation, a display array can have a displayable area usable as a screen space totaling on the order of 6 feet in height and 30 feet in width, which is wide enough for multiple users to stand at different parts of the wall and manipulate it simultaneously. It is understood that large format displays with displayable area greater than or less than the example displayable area presented above can be used by participants of the collaboration system. One or more users can also use mobile devices with small format displays to participate in a collaboration session. A mobile device 102f is shown as an example. The devices 102, which are also referred to as client nodes, have displays on which a screen space is allocated for displaying events in a workspace. The screen space for a given user may comprise the entire screen of the display, a subset of the screen, a window to be displayed on the screen and so on, such that each has a limited area or extent compared to the virtually unlimited extent of the workspace.

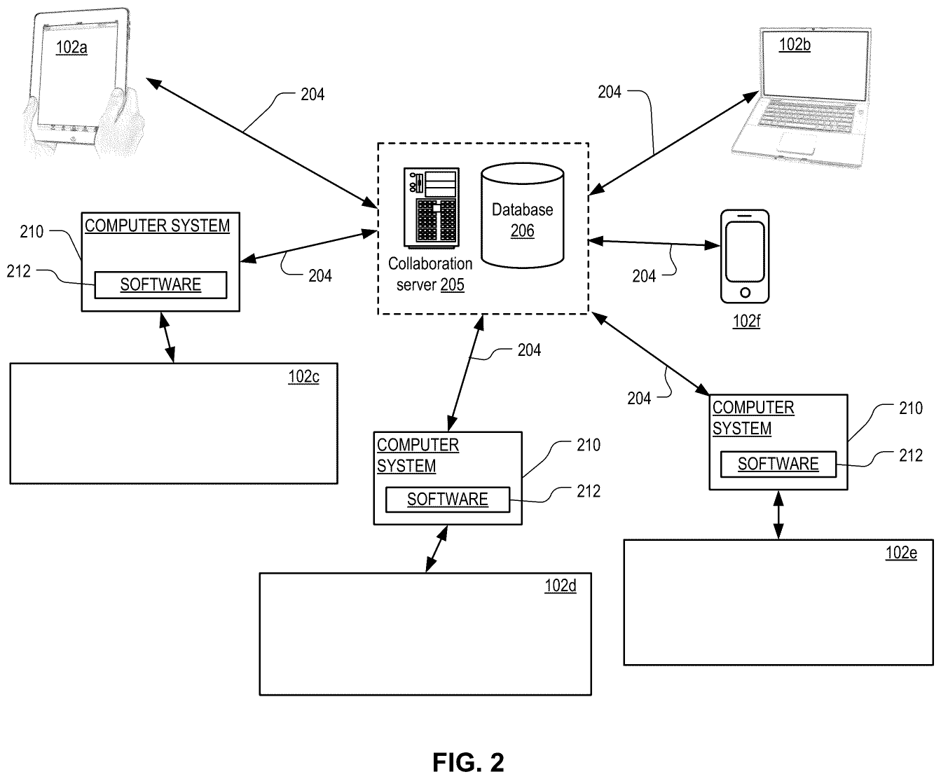

FIG. 2 illustrates a collaboration server 205 (also referred to as the server node or the server) and a database 206, which can include some or all of the spatial event map, an event map stack, the log of events, digital assets or identification thereof, etc., as described herein. In some cases, the collaboration server 205 and the database 206 collaboratively constitute a server node. The server node is configured with logic to receive events from client nodes and process the data received in these events. The server node (also referred to as collaboration server) can generate an update event related to one or more digital assets and/or a canvas and send the update even to the client nodes. The spatial event map, at respective client nodes is updated to identify the update event and to allow display of the digital asset at a selected location in the workspace in respective display spaces of respective client nodes. The selected location of the digital asset can be received by the server node in an input event from a client node.

FIG. 2 also illustrates client nodes (or client nodes) that can include computing devices such as desktop and laptop computer, hand-held devices with small format displays such as tablets, mobile computers, smart phones and large format displays that are coupled with computer system 210. Participants of the collaboration session can use a client node to participate in a collaboration session.

FIG. 2 further illustrates additional example aspects of a digital display collaboration environment. As shown in FIG. 1, the large format displays 102c, 102d, 102e sometimes referred to herein as “walls” are controlled by respective client, communication networks 204, which in turn are in network communication with a central collaboration server 205 configured as a server node or nodes, which has accessible thereto a database 206 storing spatial event map stacks for a plurality of workspaces. The database 206 can also be referred to as an event map stack or the spatial event map as described above.

As used herein, a physical network node is an active electronic device that is attached to a network, and is capable of sending, receiving, or forwarding information over a communication channel. Examples of electronic devices which can be deployed as network nodes, include all varieties of computers, workstations, laptop computers, handheld computers and smart phones. As used herein, the term “database” does not necessarily imply any unity of structure. For example, two or more separate databases, when considered together, still constitute a “database” as that term is used herein.

The application running at the collaboration server 205 can be hosted using software such as Apache or nginx, or a runtime environment such as node.js. It can be hosted for example on virtual machines running operating systems such as LINUX. The collaboration server 205 is illustrated, heuristically, in FIG. 2 as a single computer. However, the architecture of the collaboration server 205 can involve systems of many computers, each running server applications, as is typical for large-scale cloud-based services. The architecture of the collaboration server 205 can include a communication module, which can be configured for various types of communication channels, including more than one channel for each client in a collaboration session. For example, with near-real-time updates across the network, client software can communicate with the server communication module using a message-based channel, based for example on the Web Socket protocol. For file uploads as well as receiving initial large volume workspace data, the client software 212 (as shown in FIG. 2) can communicate with the collaboration server 205 via HTTPS. The collaboration server 205 can run a front-end program written for example in JavaScript served by Ruby-on-Rails, support authentication/authorization based for example on OAuth, and support coordination among multiple distributed clients. The collaboration server 205 can use various protocols to communicate with client nodes (such as devices 102). Some examples of such protocols include REST-based protocols, low latency web circuit connection protocol and web integration protocol. Details of these protocols and their specific use in the co-browsing technology is presented below. The collaboration server 205 is configured with logic to record user actions in workspace data, and relay user actions to other client nodes as applicable. The collaboration server 205 can run on the node.JS platform for example, or on other server technologies designed to handle high-load socket applications.

The database 206 stores, for example, a digital representation of workspace data sets for a spatial event map of each session where the workspace data set can include or identify events related to objects displayable on a display canvas, which is a portion of a virtual workspace. The database 206 can store digital assets and information associated therewith. A workspace data set can be implemented in the form of a spatial event stack, managed so that at least persistent spatial events (called historic events or history events) are added to the stack (push) and removed from the stack (pop) in a first-in-last-out pattern during an undo operation. There can be workspace data sets for many different workspaces. A data set for a given workspace can be configured in a database or as a machine-readable document linked to the workspace. The workspace can have unlimited or virtually unlimited dimensions. The workspace data includes event data structures identifying digital assets displayable by a display client in the display area on a display wall and associates a time and a location in the workspace with the digital assets identified by the event data structures. Each device 102 displays only a portion of the overall workspace. A display wall has a display area for displaying objects, the display area being mapped to a corresponding area in the workspace that corresponds to a viewport in the workspace centered on, or otherwise located with, a user location in the workspace. The mapping of the display area to a corresponding viewport in the workspace is usable by the display client to identify digital assets in the workspace data within the display area to be rendered on the display, and to identify digital assets to which to link user touch inputs at positions in the display area on the display.

The collaboration server 205 and database 206 can constitute a server node, including memory storing a log of events relating to digital assets having locations in a workspace, entries in the log including a location in the workspace of the digital asset of the event, a time of the event, a target identifier of the digital asset of the event, as well as any additional information related to digital assets, as described herein. The collaboration server 205 can include logic to establish links to a plurality of active client nodes (e.g., devices 102), to receive messages identifying events relating to modification, creation, deletion, movement or resizing of digital assets having locations in the workspace, to add events to the log in response to said messages, and to distribute messages relating to events identified in messages received from a particular client node to other active client nodes.

The collaboration server 205 includes logic that implements an application program interface, including a specified set of procedures and parameters, by which to send messages carrying portions of the log to client nodes, and to receive messages from client nodes carrying data identifying events relating to digital assets which have locations in the workspace. Also, the logic in the collaboration server 205 can include an application interface including a process to distribute events received from one client node to other client nodes.

The events compliant with the API can include a first class of event (history event) to be stored in the log and distributed to other client nodes, and a second class of event (ephemeral event) to be distributed to other client nodes but not stored in the log.

The collaboration server 205 can store workspace data sets for a plurality of workspaces and provide the workspace data to the display clients participating in the session. The workspace data is then used by the computer systems 210 with appropriate (client) software 212 including display client software, to determine images to display on the display, and to assign digital assets for interaction to locations on the display surface. The server 205 can store and maintain a multitude of workspaces, for different collaboration sessions. Each workspace can be associated with an organization or a group of users and configured for access only by authorized users in the group.

In some alternative implementations, the collaboration server 205 can keep track of a “viewport” for each device 102, indicating the portion of the display canvas (or canvas) viewable on that device, and can provide to each device 102 data needed to render the viewport. The display canvas is a portion of the virtual workspace. Application software running on the client device responsible for rendering drawing objects, handling user inputs, and communicating with the server can be based on HTML5 or other markup-based procedures and run in a browser environment. This allows for easy support of many different client operating system environments.

The user interface data stored in database 206 includes various types of digital assets including graphical constructs (drawings, annotations, graphical shapes, etc.), image bitmaps, video objects, multi-page documents, scalable vector graphics, and the like. The devices 102 are each in communication with the collaboration server 205 via a communication network 204. The communication network 204 can include all forms of networking components, such as LANs, WANs, routers, switches, Wi-Fi components, cellular components, wired and optical components, and the internet. In one scenario two or more of the users 101 are located in the same room, and their devices 102 communicate via Wi-Fi with the collaboration server 205.

Two or more of the users 101 can be separated from each other by thousands of miles and their devices 102 communicate with the collaboration server 205 via the internet. The walls 102c, 102d, 102e can be multi-touch devices which not only display images, but also can sense user gestures provided by touching the display surfaces with either a stylus or a part of the body such as one or more fingers. In some embodiments, a wall (e.g., 102c) can distinguish between a touch by one or more fingers (or an entire hand, for example), and a touch by the stylus. In one embodiment, the wall senses touch by emitting infrared light and detecting light received; light reflected from a user's finger has a characteristic which the wall distinguishes from ambient received light. The stylus emits its own infrared light in a manner that the wall can distinguish from both ambient light and light reflected from a user's finger. The wall 102c may, for example, be an array of Model No. MT553UTBL MultiTaction Cells, manufactured by MultiTouch Ltd, Helsinki, Finland, tiled both vertically and horizontally. In order to provide a variety of expressive means, the wall 102c is operated in such a way that it maintains a “state.” That is, it may react to a given input differently depending on (among other things) the sequence of inputs. For example, using a toolbar, a user can select any of a number of available brush styles and colors. Once selected, the wall is in a state in which subsequent strokes by the stylus will draw a line using the selected brush style and color.

### Collaborating Using Devices Having Digital Displays of Different Sizes

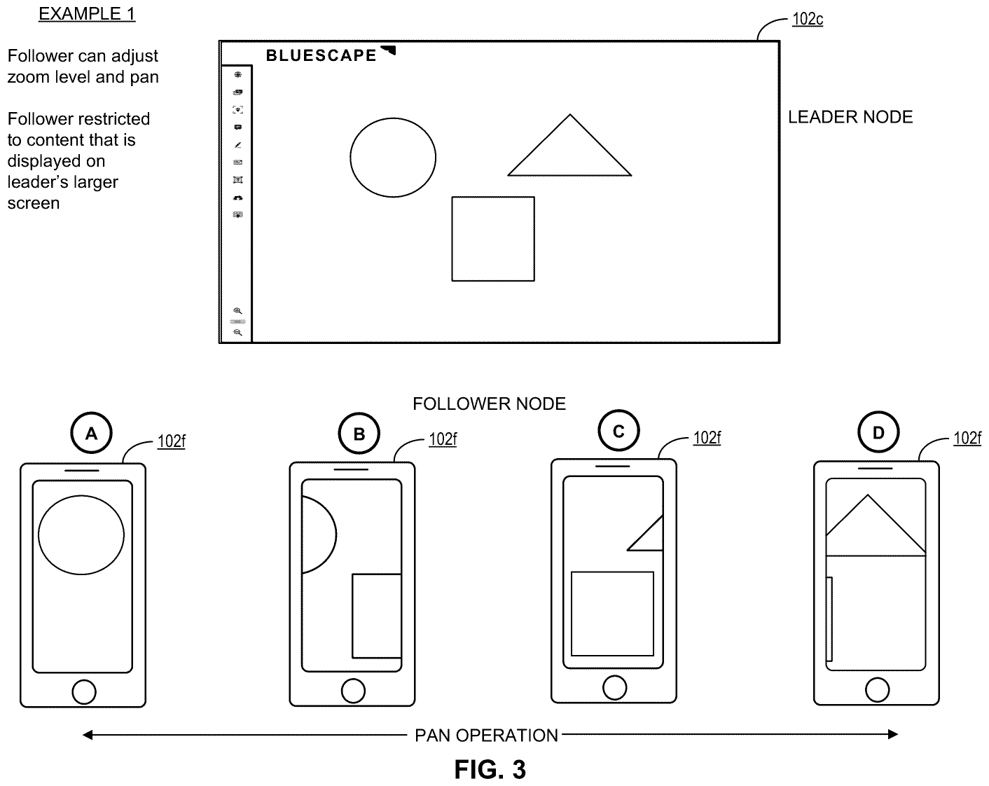

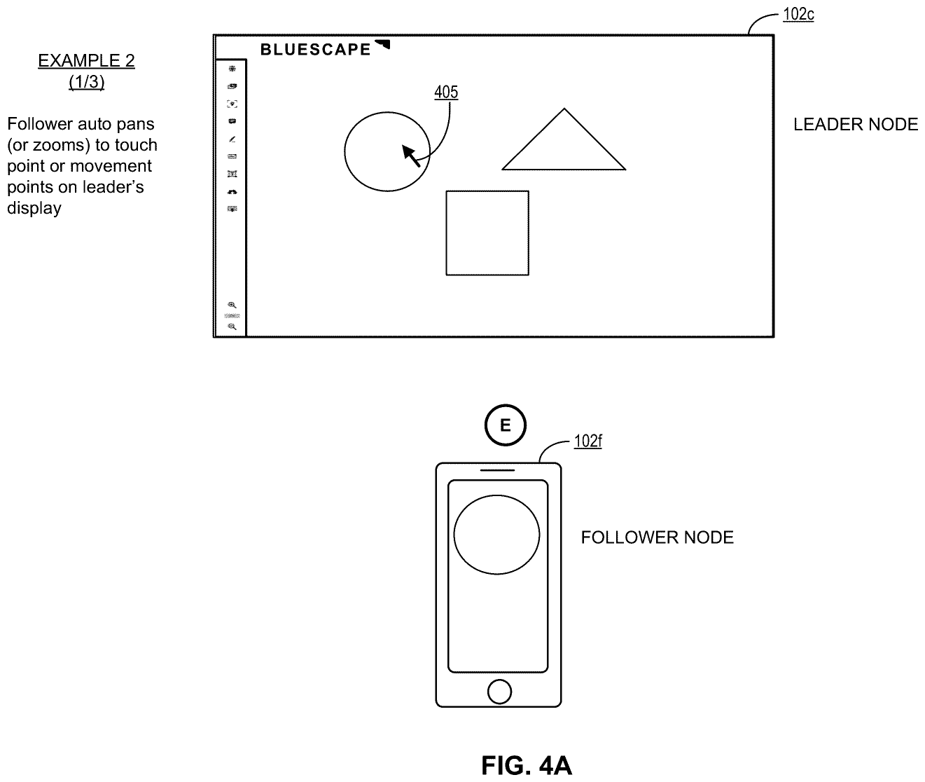

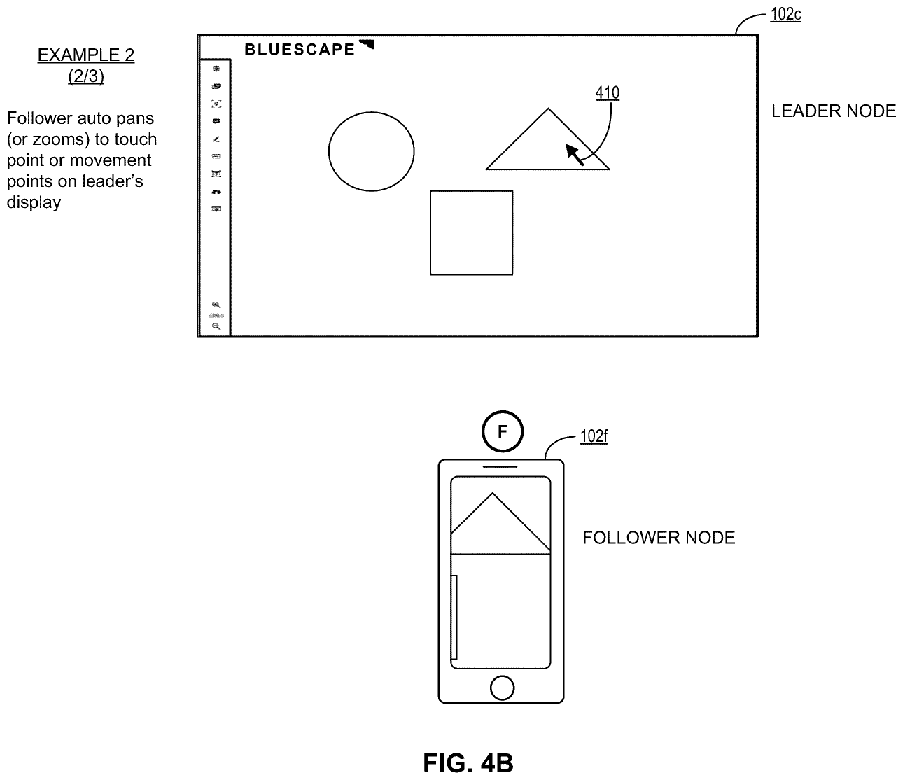

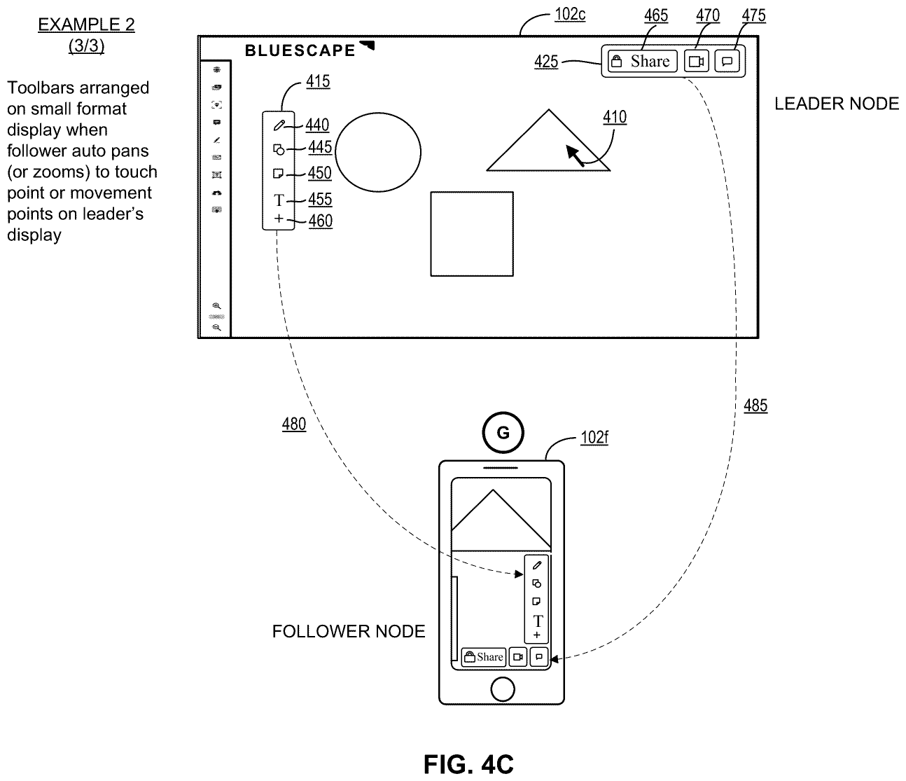

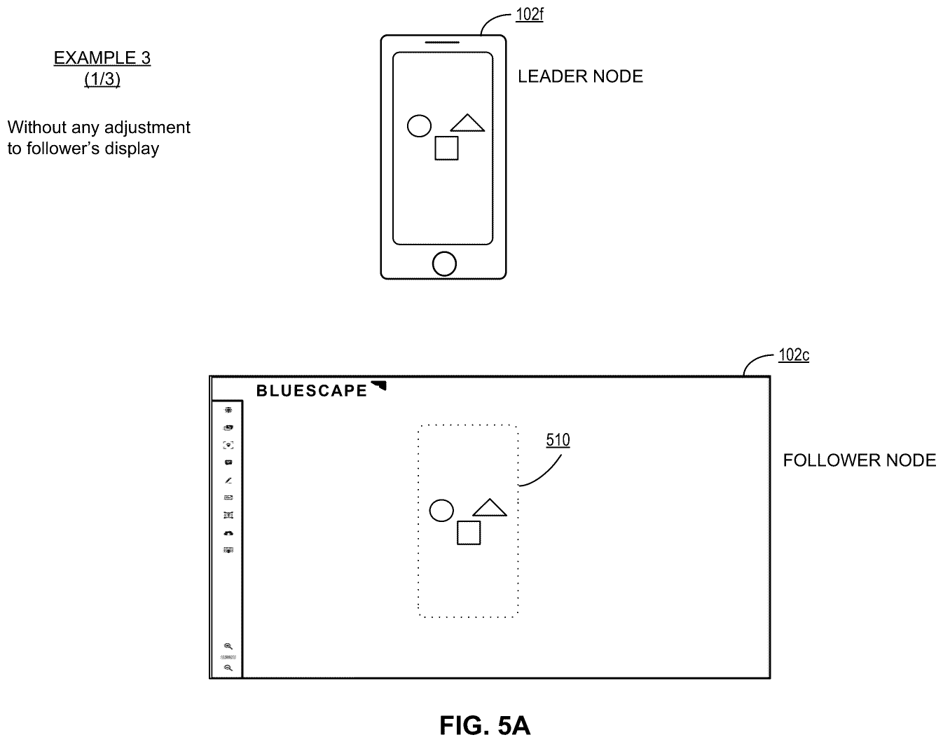

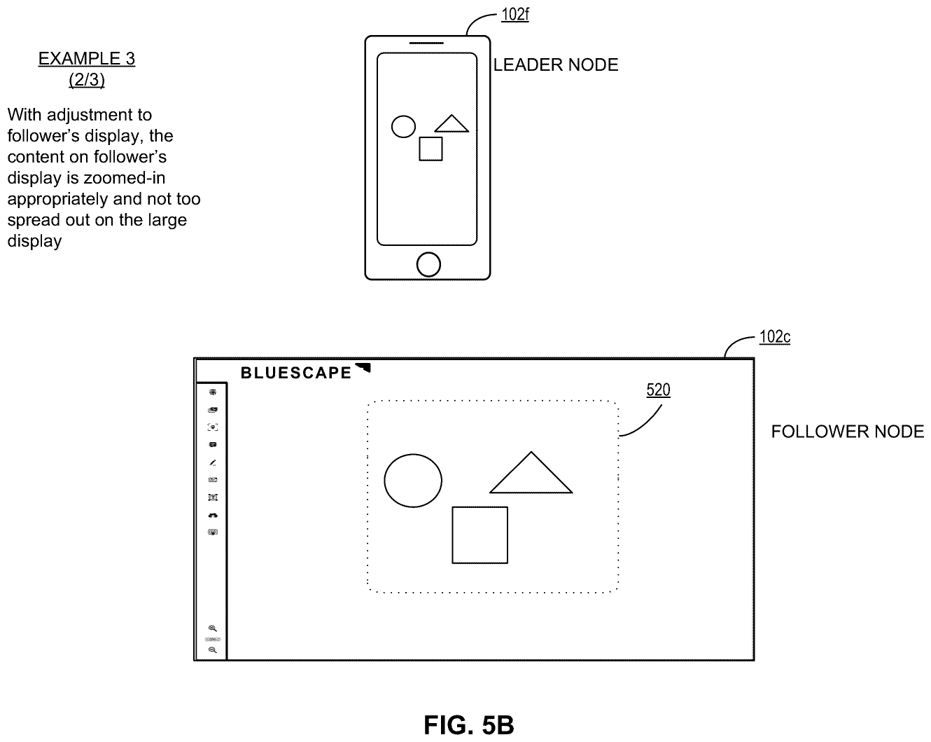

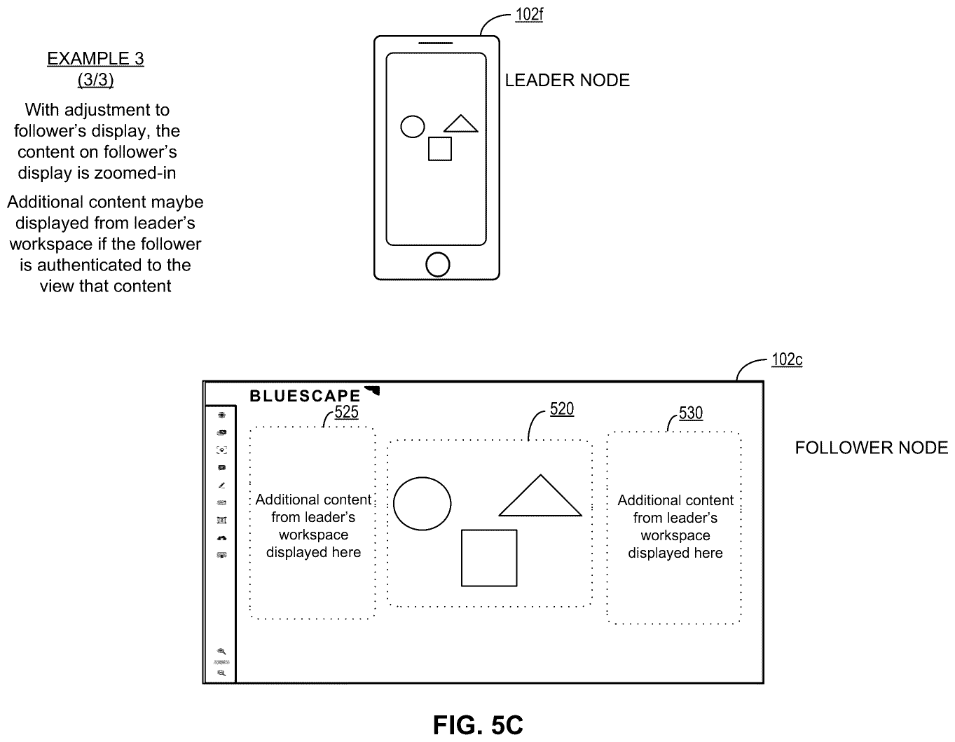

FIGS. 3 to 5C provide various implementations of the technology disclosed in which a follower and a leader participate in a collaboration session. Examples of collaboration sessions in FIGS. 3 and 4A to 4C illustrate a follower using the mobile device 102f with a small format display viewing content shared by a leader using a large format display 102c. FIGS. 5A to 5C present an example in which the leader is using the mobile device 102f with a small format display to share content with a follower who is viewing the shared content on a large format display 102c. Only two participants (a leader and a follower) are shown in a collaboration session in the following examples for illustration purpose. It is understood that any number of participants can participate in a collaboration session using the technology disclosed. A follower can become a leader and a leader can become a follower during the collaboration session. The collaboration sessions can also be conducted in asynchronous mode, i.e., all participants can collaboratively work on overlapping or separate portions (or regions) of a workspace. In asynchronous collaboration sessions, a leader-follower model is not followed and all participants collaboratively work on their own pace. The technology disclosed can automatically adjust the size of digital assets in asynchronous mode collaboration sessions when such digital assets are displayed on small format displays so that the content is easily viewed by a user. Additionally, the technology disclosed can automatically adjust the size, location and arrangement of various types of toolbars in dependence on the display size of a digital display. Further details of these features are presented in the following sections.

### Leader Using Large Format Display and Follower Using Small Format Display

FIG. 3 presents an example in which the leader is sharing content using a large format digital display 102c. The device 102c is also referred to as a leader node in FIG. 3 as the leader is using this device to share content with one or more followers. The content shared by the leader in this example includes three shapes: a circle, a square and a triangle as shown on a large format display of the leader node (102c). The follower is viewing content shared by the leader using a mobile device 102f having a small format display. The mobile device 102f is referred to as a follower node in FIG. 3. Four views, labeled as A, B, C, and D of the display of the mobile device 102f are illustrated in FIG. 3. It can be seen that only a part of the content shared by the leader on the large format digital display is displayed in each of the four views A, B, C, and D. The display size of the small format display of the mobile device is very small as compared to the display size of the large format display. Therefore, all content displayed on the large format display cannot be displayed on the small format display without zooming out to a level that it become difficult to view. For example, the display size of the mobile device can be 5 inches (measured diagonally) whereas the size of the large format device can be 60 inches or more (measured diagonally). The large format display can be up to ten times or more the size of the small format display of the mobile device. In some cases, the large format display can be fifteen to twenty times larger than the display size of the small format display.

Large differences in display sizes of large format displays and small format displays make it difficult to view the collaboration data (or digital assets) displayed on the large format display by directly mapping it to the small format displays without any adjustments in the size of the content. For example, if the circle, square and triangle, as displayed on the large format digital display 102c, were all displayed the mobile device 102f at the same time, then the sizes of the circle, square and triangle would be so small that the user would have difficulty viewing the specific details of circle, square and triangle. Suppose there were specific details within the circle. The user would not be able to see them, because each of the circle, square and triangle would be so small so that they can fit onto the screen of the mobile device 102f at the same time. Furthermore, situations can arise when the differences in screen size is so substantial that not all content (or digital assets) in the collaboration data (or workspace) displayed on the large format display can be displayed on the small format display as the available display space on small format displays is too limited.

The technology disclosed includes logic to adjust the size of the content shared by the leader on the large format display when displaying the content on small format display used by the follower so that it is easy to view. For example, when the display size of the small format device is one tenth of the large format display, the server node can reduce (or decrease) the size of the content (digital assets) by ten times. It is understood that the server node can use other size reduction values when displaying content on a small format display. For example, if the display size of the small format device is one tenth of the display size of the large format display, the server node can decrease the size of the content by five times or if the display size of the small format device is one fourth of the display size of the large format display, the server node can reduce the size of the digital assets by one half i.e., ½ times the size of the digital assets as displayed on the display linked to the large format display. In one implementation, the system allows the user to select a size reduction value for reducing the size of the content when displaying the content on a small format display.

The four example views A, B, C, and D of the small format display in FIG. 3 of the mobile device 102f, display part of the content displayed on the large format display 102c used by the leader. A pan operation can be performed at the follower node to view content not visible on the small format display. The follower (such as the user or participant following the leader) can perform the pan operation by interacting with the display of the follower node (such as a mobile device or another type of computing device used by the follower) using a pointing device or by using a finger, stylus, pen, etc. The pan operation can move at least a portion of one or more digital assets on the display linked to the follower node. An update event can be sent from the follower node to the server node in response to the pan operation. The server node can generate an updated data for the follower node by removing digital assets (or portions of digital assets) outside the mapped display coordinates of the display linked to the follower node as a result of the pan operation. The server node can include in the updated data, the digital assets (or portions of digital assets) with locations mapping inside the display coordinates of the display linked to the follower node as a result of the pan operation. The server node sends the updated data to the follower node, thus allowing the follower to view the content shared by the leader in any direction on the small format display. Note that the four views A, B, C, and D of the small format display of the follower node (i.e., the mobile device 102f) are shown for illustration.

In the first view labeled as “A”, a circle-shaped graphical object from canvas on the large format digital display 102c is displayed on small format digital display of the mobile device 102f. As illustrated, the square and the triangle that is in the viewport of the leader is not displayed on the small format digital display. The follower can pan to the right, thus allowing the content positioned on the right-side of the circle to be displayed on the small format digital display of the mobile device. For example, in the second view labeled as “B” a square-shaped graphical object is partially displayed on the small format display of the mobile device along with a part of the circle-shaped graphical object. As the follower keeps panning towards the right, the square-shaped graphical object is completely displayed on the small format display of the mobile device in the view labeled as “C.” However, note that the circle-shaped graphical object is no longer displayed on the small format display of the mobile device in the view “C.” This is because there is not enough display space on the small format display of the mobile device hence only a part of the canvas from the leader's large format digital display is displayed in one view. Finally, in the view labeled as “D”, an almost complete triangle-shaped graphical object is displayed on the small format display of the mobile device 102f.

The follower can adjust the zoom level on the display of the small format display of the mobile device to zoom-in or zoom-out when viewing the content displayed on the canvas shared by the leader in a collaboration session. When the display is zoomed-in, the follower can view less content from the leader's canvas on the display of the mobile device. When the display is zoomed-out, the follower can view more content on the display of the mobile device.

The example presented in FIG. 3 illustrates that any given view (such as labeled A, B, C and D in FIG. 3) of the small format display of the mobile device 102f can display part of the content displayed on the canvas (or shared digital workspace) of the leader shared from large format digital display. For example, the views labeled as A, B, C, and D display only a part of the content displayed on the large format digital display 102c. Therefore, only a part of the content (from canvas shared by the leader) is displayed on the small format display of the mobile device of the follower when the leader shares the canvas using a large format digital display 102c.

In one implementation, the collaboration server can send the complete spatial event map (SEM) containing all digital assets in the shared canvas to the client-side device of the follower (i.e., the mobile computing device in FIG. 3) when the collaboration meeting starts. In this implementation, the client-side device includes logic to restrict display of the canvas to only a part of the spatial event map that includes digital assets that map to the current viewport displayed on the small format display. The client-side device includes logic to update the content displayed on the small format display as the follower pans to view other content on the shared canvas. Similarly, the client-side device includes logic to update the content displayed on the small format display as the follower zooms-in or zooms-out. In this implementation, the digital assets that are positioned outside the boundaries of the display boundary of the small format display are not displayed on the display of the mobile device used by the follower. The client-side computing device, therefore, includes logic to present the canvas in a restricted view on the small format display. In this restricted view, only a part of canvas is displayed on the small format display of the mobile device. The spatial event map can include a data structure to store coordinates of two-dimensional or three-dimensional boundary of the small format display of the mobile device 102f. The client-side device includes logic to only display digital assets in the shared canvas that are within the boundary of the display of the leader. For the digital assets that are positioned on the boundary only part of the digital assets that are positioned inside the boundary of the leader may be displayed and other parts that are positioned outside the boundary of the small format display may not be displayed.

In one implementation, the collaboration server includes logic to send only a part of the spatial event map (or SEM) to follower node (i.e., the client-side device used by the following user) that matches the display size of the large format display of the leader node. In this implementation, the server node (or collaboration server) can send all of the collaboration data (or digital assets) within the viewport of the leader node with large format display to the follower node with small format display. However, the server node includes logic to identify (or flag) the data (i.e., the digital assets) that is within the smaller viewport of the follower node. This identification or flagging allows the follower node to display only the digital assets that are within the smaller viewport of the small format display of the follower node. The identification data allows the follower node to prevent display of digital assets that are outside the viewport of the small format display of the follower node. The data sent to follower node allows the follower node to select the part of the SEM that includes digital assets having locations mapped to current viewport of the small format display so only a portion of the digital assets from the viewport of the large format display are displayed on the small format display of the follower node. This allows the follower node (such as mobile device 102f) with small format display to follow the viewport of the large format display but only shows a portion (or part) of the SEM data that includes the digital assets that are within the viewport of the leader. This allows the follower node to always keep the following user bound to viewport of the leader.

In another implementation, the collaboration server includes logic to send only a part of the spatial event map (or SEM) to follower node that includes digital assets mapped to a smaller portion of the current viewport of the large format display. This allows the server node to send even less data (i.e., digital assets) to a follower node than the data sent in the implementation described above. In this implementation, the server node sends SEM data (to follower node) that only includes a sub-set of the digital assets that are within the viewport of the leader. The partial SEM data sent by the collaboration server (or the server node) to the follower node (i.e., the client device or the mobile device used by the follower) allows the follower node to display the partially received SEM as is without making any further changes to the displayed content. Therefore, in this implementation, the logic to adjust the display of content on the small format display of the follower node is implemented at the server node or the collaboration server. As the follower pans to view additional content in the canvas shared by the leader, the follower node sends an update event to the collaboration server with updated viewport. The collaboration server upon receiving the updated viewport, determines the content in the shared canvas that maps to the location of the updated canvas of the mobile device. The digital assets in the updated mapping of the SEM to the viewport of the follower node, are then sent to the follower node. The follower node then uses the updated SEM to update digital assets displayed on the small format display.

The technology disclosed can make an initial determination as to what portion of the leader's viewport should be provided to (or focused in on by) the mobile device for display. For example, if the center area of the leader node's viewport displays the square, then the default would be for the mobile device to initially focus in on the square, as illustrated in view “C” of FIG. 3. Alternatively, if the leader has selected the circle or has moved a cursor to a location near or on the circle, then the default would be for the mobile device to initially focus in on the circle, as illustrated in view “A” of FIG. 3. Other method for determining what portion of the leader's viewport should be focused in on by the mobile device can also be implemented. Some of these scenarios are described below with reference to FIGS. 4A and 4B.

FIGS. 4A and 4B present another example in which the leader shares digital assets using a large format digital display of the leader node and the follower views shared content (i.e., the digital assets) using a small format display of the follower node i.e., the mobile device 102f. In this example, the small format display of the follower node auto pans to locations on the workspace that are currently touched by the leader on the large format digital display. The small format display of the follower node can also auto pan to locations on the workspace displayed on the large format digital display of the leader node where a pointer is positioned. For example, in FIG. 4A, a current position of the pointer on the large format display is indicated by an “arrow” 405. The pointer 405 is located inside the circle-shaped graphical object. The server node sends the spatial event map and the location data of the leader's interaction with the workspace (such as location of the pointer 405 in FIG. 4A) to the follower node. This data allows the follower node to automatically display a portion of the workspace located close to the pointer 405 on the small format display of the follower node (i.e., the mobile device 102f). A view of the small format display, labeled as “E” in FIG. 4A, shows content displayed on the small format display of the follower node (102f). This view shows that the circle-shaped graphical object, which is positioned close to the pointer 405 (on leader node), is displayed on the small format digital display of the mobile device 102f and other content on the leader's viewport on the large format display as shown in FIG. 4A is not displayed on the small format display.

FIG. 4B illustrates how the content displayed on the small format display of the follower node is updated based on movement of the pointer (or touch point) on the large format digital display of the leader node. In FIG. 4B, the location of the pointer is labeled as 410 on the large format display. The location 410 of the pointer is updated in FIG. 4B and the new location of the pointer is close to a triangle-shaped digital asset (or graphical object) on the workspace. The server node sends an update event to the follower node to update the location of the pointer thus indicating the current location on the workspace at which the leader is interacting with digital assets. The data sent to the follower node (i.e., the mobile device 102f) allows the follower node to automatically update the viewport of the workspace and display the digital assets on the small format display of the follower node that are closer to the location at which the leader is interacting with the digital assets on the workspace. A view labeled as “F” shows content displayed on the small format display of the mobile device after receiving the update event from the server node. The view “F” shows that the viewport of the workspace on the small format display of the follower device i.e., the mobile device 102f is updated to display the triangle-shaped digital asset that is positioned close to new location 410 of the pointer on the workspace as displayed on the large format digital display 102c. Therefore, the server node allows the follower node to display content on the small format display that is located closer to the location on the workspace at which the leader is interacting using the large format display of the leader node.

FIG. 4C presents an example in which toolbars 415 and 425 positioned on two different locations on the large format display of the leader node are automatically arranged on the small format display of the follower node. The toolbars can provide user interface elements such as controls or tools to edit digital assets or perform other operations in a collaboration session. For example, the toolbar 415 includes controls or buttons to draw lines (440), draw shapes (445), edit images (450), edit text (455) and add new digital assets (460) to the workspace. The toolbar 425 includes controls or buttons (or user interface elements) to share the workspace and/or digital assets with other users (465), to start a video conference (470) or to open a chat window (475) to communicate with other users participating in the collaboration session. The toolbar 415 is located close to the left edge of the large format display of the leader node (102c). The toolbar 425 is located on the top-right corner of the large format display of the leader node (102c). The server node receives toolbar data from the leader node identifying one or more toolbars including user interface elements (such as buttons or controls) in respective toolbars. The toolbar data received from the leader node further includes a source location and a source dimension of the respective toolbar as displayed on the display linked to the leader node. The source dimension can comprise a length and a width (e.g., in pixels) of the toolbar. The toolbar data can include the data indicating the user interface elements and their arrangement in the toolbar. The arrangement can indicate the sequence, such as from left to right or from top to bottom, in which the user interface elements or buttons or controls are positioned in the toolbar. The toolbar data can also include a priority or ranking of the user interface elements. The ranking or priority data can be used by the server to select the one or more tools for display when the toolbar is displayed in a collapsed mode. In a collapsed mode, the toolbar displays only a few or one user interface element (such as the button or the control) having a high priority. In a collapsed mode, the toolbar requires less area for display on the display screen. A user can select the toolbar to expand it causing the toolbar to display the user interface elements that were hidden and not displayed in the collapsed mode.

The server node includes logic to determine a target location of the toolbar for display on the display linked to the follower node. The example illustrated in FIG. 4C includes a follower node 102f with a small format device. As the display size of the follower node is small, the server node determines a target dimension (e.g., height and width of the toolbar in pixels) for the toolbar for display on the small format display of the follower node. The target location maps the toolbar inside the mapped display coordinates of the display linked to the follower node. The target location and the target dimension are determined so that the toolbar does not overlap any digital assets displayed on the display of the follower node. The toolbar data sent to the follower node allows the follower node to automatically place the toolbars on a portion of the small format display such that the toolbars do not block active content or digital assets. For example, in FIG. 4C, the leader is pointing on a triangle as shown by a pointer at a location 410, positioned on the triangle displayed on the large format display. The server node automatically positions the toolbars 415 and 425 along the right edge and bottom edge of the small format display of the follower node, respectively such that the toolbars do not block the triangle object. The broken lines 480 and 485 illustrate a mapping of the toolbars 415 and 415, respectively, from the large format display of the leader node (102c) to the small format display of the follower node (102f). A view labeled as “G” shows content and the toolbars displayed on the small format display of the follower node after receiving the update event from the server node. The update event can include the toolbar data sent from the server node to the follower node. The respective sizes of the toolbars are reduced so that these can fit in the limited space available on the small format display. In one implementation, a toolbar can be collapsed so that only a selected number of tools are visible on the toolbar. The user can select the toolbar to expand it and view all the tools or controls in the toolbar. Further details of the toolbar technology are presented in our U.S. Application No. 63/459,223 (Atty. Docket No. HAWT 1047-1), entitled, “Method and System for Summoning Adaptive Toolbar Items and Digital Assets Associated Therewith on a Large Format Screen Within a Digital Collaboration Environment,” filed on Apr. 13, 2023, which is incorporated by reference and fully set forth herein.

### Leader Using Small Format Display and Follower Using Large Format Display

FIGS. 5A to 5C present an example in which the leader shares a workspace using a small format display of a leader node such as the mobile device 102f. The follower views content shared by the leader using a large format digital display of the follower node (e.g., the wall 102c). FIG. 5A shows an example in which the content on the workspace shared by the leader in a collaboration session is displayed on the leader's mobile device with a small format display. The follower is viewing the content on the workspace shared by the leader on a large format display of the follower node. As the display size of the small format display of the mobile device is smaller than the display size of the large format display of the follower node (102c), the shared content is displayed in a small part (or a small portion) 510 of the display area of the large format display of the follower node. Therefore, without the use of the technology disclosed, the content shared by the leader using a small format display is displayed in a small part of display on the large format display. This may not be suitable for viewing on the large format display as a large part of the display area of the large format display remains unutilized or unused. FIG. 5A shows that the shared content is displayed within a small portion 510 of the display area of the large format display. The area to the left and the right of the portion 510 remains blank or unutilized.

The technology disclosed can automatically adjust the zoom level of the content on the shared canvas for display on the large format display so that it is suitable for viewing by the follower. FIG. 5B shows an example in which the content from the workspace shared by the leader using a leader node with a small format display (such as the mobile device 102f) is adjusted according to the display size of the large format display of the follower node. The content is zoomed-in to display the digital assets at an appropriate size for viewing on the large format display. For example, in FIG. 5B, the content is displayed in a larger display area 520 as compared to a smaller area 510 in FIG. 5A. The content is not zoomed-in to such a level that it is spread out on the large format display which makes it difficult for the follower to view and understand the content.

FIG. 5C presents another implementation of the technology disclosed in which the leader uses a mobile device with a small format display to share content on a workspace. The follower uses a large format display to view content shared by the leader. In this implementation, the system includes logic to utilize additional space on the left and/or right side of the content displayed on the large format digital display. For example, in FIG. 5C, additional content can be displayed from the shared canvas in the spaces 525 and 530. This additional content from the shared canvas cannot be displayed on the small format display of the mobile device of the leader due to small display space. In one implementation, the additional content is only displayed on the follower node's display when the follower has authorization to view that content. In such an implementation, the system includes logic to automatically complete the authorization process before displaying content in spaces 525 and/or 530. The authorization process can include receiving an approval from content owner which can be the meeting leader or another participant or user of the collaboration system. Furthermore, rather than displaying additional content from other portions of the leader's canvas, the system can provide additional information about the digital assets in the display area 520 to spaces 525 and/or 530. Moreover, spaces 525 and/or 530 can include information related to other participants of the collaboration. It is understood that any information selected by one or more participants of the collaboration session or an administrator of the collaboration session can be displayed in the spaces 525 and 530.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the technology disclosed may consist of any such feature or combination of features. In view of the foregoing description, it will be evident to a person skilled in the art that various modifications may be made within the scope of the technology disclosed. Some or all of the operations that are described above as being performed by the server node can also be performed by a client node (such as the leader node and/or the follower node).

### Computer System

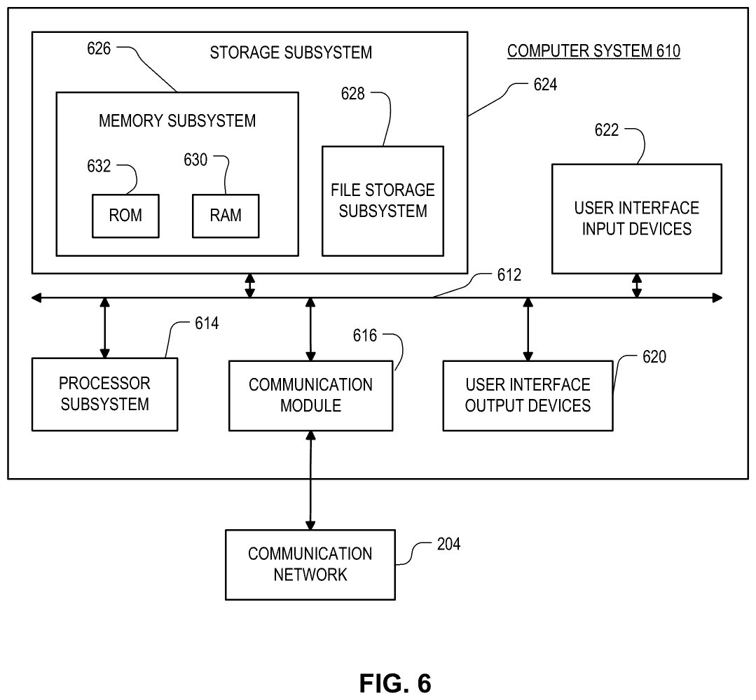

FIG. 6 is a simplified block diagram of a computer system, or network node, which can be used to implement the client functions (e.g., computer system 210) or the server-side functions (e.g., server 205) for sending data to client nodes in a collaboration system. A computer system typically includes a processor subsystem 614 which communicates with a number of peripheral devices via bus subsystem 612. These peripheral devices may include a storage subsystem 624, comprising a memory subsystem 626 and a file storage subsystem 628, user interface input devices 622, user interface output devices 620, and a communication module 616. The input and output devices allow user interaction with the computer system. Communication module 616 provides physical and communication protocol support for interfaces to outside networks, including an interface to communication network 204, and is coupled via communication network 204 to corresponding communication modules in other computer systems. Communication network 204 may comprise many interconnected computer systems and communication links. These communication links may be wireline links, optical links, wireless links, or any other mechanisms for communication of information, but typically it is an IP-based communication network, at least at its extremities. While in one embodiment, communication network 204 is the Internet, in other embodiments, communication network 204 may be any suitable computer network.

The physical hardware component of network interfaces is sometimes referred to as network interface cards (NICs), although they need not be in the form of cards: for instance, they could be in the form of integrated circuits (ICs) and connectors fitted directly onto a motherboard, or in the form of macrocells fabricated on a single integrated circuit chip with other components of the computer system.

User interface input devices 622 may include a keyboard, pointing devices such as a mouse, trackball, touchpad, or graphics tablet, a scanner, a touch screen incorporated into the display (including the touch sensitive portions of large format digital display such as 102c), audio input devices such as voice recognition systems, microphones, and other types of tangible input devices. In general, use of the term “input device” is intended to include all possible types of devices and ways to input information into the computer system or onto communication network 204.

User interface output devices 620 may include a display subsystem, a printer, a fax machine, or non-visual displays such as audio output devices. The display subsystem may include a cathode ray tube (CRT), a flat panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from the computer system to the user or to another machine or computer system.

Storage subsystem 624 stores the basic programming and data constructs that provide the functionality of certain embodiments of the present invention.

The storage subsystem 624 when used for implementation of server nodes, comprises a product including a non-transitory computer readable medium storing a machine-readable data structure including a spatial event map which locates events in a workspace, wherein the spatial event map includes a log of events, entries in the log having a location of a graphical target of the event in the workspace and a time. Also, the storage subsystem 624 comprises a product including executable instructions for performing the procedures described herein associated with the server node.

The storage subsystem 624 when used for implementation of client-nodes, comprises a product including a non-transitory computer readable medium storing a machine readable data structure including a spatial event map in the form of a cached copy as explained below, which locates events in a workspace, wherein the spatial event map includes a log of events, entries in the log having a location of a graphical target of the event in the workspace and a time. Also, the storage subsystem 624 comprises a product including executable instructions for performing the procedures described herein associated with the client node.

For example, the various modules implementing the functionality of certain embodiments of the invention may be stored in storage subsystem 624. These software modules are generally executed by processor subsystem 614.

Memory subsystem 626 typically includes a number of memories including a main random-access memory (RAM) 630 for storage of instructions and data during program execution and a read only memory (ROM) 632 in which fixed instructions are stored. File storage subsystem 628 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs and may be stored by file storage subsystem 628. The host memory 626 contains, among other things, computer instructions which, when executed by the processor subsystem 614, cause the computer system to operate or perform functions as described herein. As used herein, processes and software that are said to run in or on the “host” or the “computer,” execute on the processor subsystem 614 in response to computer instructions and data in the host memory subsystem 626 including any other local or remote storage for such instructions and data.

Bus subsystem 612 provides a mechanism for letting the various components and subsystems of a computer system communicate with each other as intended. Although bus subsystem 612 is shown schematically as a single bus, alternative embodiments of the bus subsystem may use multiple busses.

The computer system 610 itself can be of varying types including a personal computer, a portable computer, a workstation, a computer terminal, a network computer, a television, a mainframe, a server farm, or any other data processing system or user device. In one embodiment, a computer system includes several computer systems, each controlling one of the tiles that make up the large format display such as 102c. Due to the ever-changing nature of computers and networks, the description of computer system 210 depicted in FIG. 6 is intended only as a specific example for purposes of illustrating the preferred embodiments of the present invention. Many other configurations of the computer system are possible having more or less components than the computer system depicted in FIG. 6. The same components and variations can also make up each of the other devices 102 in the collaboration environment of FIG. 1, as well as the collaboration server 205 and database 206 as shown in FIG. 2.

Certain information about the drawing regions active on the digital display 102c are stored in a database accessible to the computer system 210 of the display client. The database can take on many forms in different embodiments, including but not limited to a MongoDB database, an XML database, a relational database, or an object-oriented database.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present technology may consist of any such feature or combination of features. In view of the foregoing description, it will be evident to a person skilled in the art that various modifications may be made within the scope of the technology.

The foregoing description of preferred embodiments of the present technology has been provided for the purposes of illustration and description. It is not intended to be exhaustive or to limit the technology to the precise forms disclosed. Obviously, many modifications and variations will be apparent to practitioners skilled in this art. For example, though the displays described herein are of large format, small format displays can also be arranged to use multiple drawing regions, though multiple drawing regions are more useful for displays that are at least as large as 12 feet in width. In particular, and without limitation, any and all variations described, suggested by the Background section of this patent application or by the material incorporated by reference are specifically incorporated by reference into the description herein of embodiments of the technology. In addition, any and all variations described, suggested or incorporated by reference herein with respect to any one embodiment are also to be considered taught with respect to all other embodiments. The embodiments described herein were chosen and described in order to best explain the principles of the technology and its practical application, thereby enabling others skilled in the art to understand the technology for various embodiments and with various modifications as are suited to the particular use contemplated. It is intended that the scope of the technology be defined by the following claims and their equivalents.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the technology disclosed and the scope of the following claims. It is contemplated that technologies described herein can be implemented using collaboration data structures other that the spatial event map.

What is claimed is:

1. A method of a server node sending data identifying digital assets in a workspace, the method including:
receiving, at a server node and from a leader node, data identifying digital assets in the workspace.
identifying, by the server node and from the received data, data identifying first digital assets from the digital assets, wherein the first digital assets have locations outside mapped display coordinates of a display linked to a follower node following the leader node; and
sending, to the follower node, the received data identifying the digital assets in the workspace and the data identifying the first digital assets,
wherein the data sent to the follower node allows display, on the display linked to the follower node, of only digital assets in the workspace with locations mapping inside the mapped display coordinates of the display linked to the follower node and prevents display of the first digital assets with locations outside mapped display coordinates of the display linked to the follower node.

2. The method of claim 1, wherein a size of a display linked to the leader node is at least four times larger than a size of the display linked to the follower node.

3. The method of claim 1, wherein the leader node is used by a leader participant presenting collaboration data to a follower participant using the follower node.

4. The method of claim 1, wherein the data sent to the follower node, allows a reduction in a size of the displayed digital assets, when displaying the digital assets on the display linked to the follower node.

5. The method of claim 4, wherein the reduction in the size of the digital assets reduces the size of the digital assets by ½ times the size of the digital assets as displayed on a display linked to the leader node.

6. The method of claim 1, further including:
generating, by the server node and from the received data identifying the digital assets in the workspace, a reduced set of data by removing the data identifying the first digital assets; and
sending, from the server node to the follower node, the reduced set of data, wherein, the reduced set of data identifies digital assets in the workspace with locations mapping inside the mapped display coordinates of the display linked to the follower node and the reduced set of data does not include the first digital assets.

7. The method of claim 6, further including:
receiving, at the server node, an update event from the follower node indicating a pan operation in response to an input received at the follower node, wherein the pan operation moves at least a portion of the digital assets on the display linked to the follower node;
generating, from the received data identifying the digital assets in the workspace, a second reduced set of data by removing data identifying digital assets moved outside of the mapped display coordinates of the display linked to the follower node and including one or more of the first digital assets that are inside of the coordinates of the display linked to the follower node as a result of the update event; and
sending, from the server node and to the follower node, the second reduced set of data, wherein, the second reduced set of data identifies digital assets in the workspace with locations mapping inside the mapped display coordinates of the display linked to the follower node and the second reduced set of data does not include one or more of the first digital assets that have locations outside mapped display coordinates of the display linked to the follower node as a result of the update event.

8. The method of claim 1, wherein the received data further includes toolbar data identifying a toolbar including user interface elements, the toolbar data further identifying a source location and a source dimension of the toolbar as displayed on the display linked the leader node, the method further including:
determining a target location and a target dimension of the toolbar for display on the display linked to the follower node, wherein the target location maps inside the mapped display coordinates of the display linked to the follower node and the target location and the target dimension prevent overlap of the toolbar with digital assets displayed in the display linked to the follower node.

9. A system including one or more processors coupled to memory, the memory loaded with computer instructions to send data identifying digital assets in a workspace, the instructions, when executed on the processors, implement, at a server node, actions comprising:
receiving, at a server node and from a leader node, data identifying digital assets in the workspace.
identifying, by the server node and from the received data, data identifying first digital assets from the digital assets, wherein the first digital assets have locations outside mapped display coordinates of a display linked to a follower node following the leader node; and
sending, to the follower node, the received data identifying the digital assets in the workspace and the data identifying the first digital assets,
wherein the data sent to the follower node allows display, on the display linked to the follower node, of only digital assets in the workspace with locations mapping inside the mapped display coordinates of the display linked to the follower node and prevents display of the first digital assets with locations outside mapped display coordinates of the display linked to the follower node.

10. The system of claim 9, wherein a size of a display linked to the leader node is at least four times larger than a size of the display linked to the follower node.

11. The system of claim 9, wherein the leader node is used by a leader participant presenting collaboration data to a follower participant using the follower node.

12. The system of claim 9, wherein the data sent to the follower node, allows a reduction in a size of the displayed digital assets, when displaying the digital assets on the display linked to the follower node.

13. The system of claim 12, wherein the reduction in the size of the digital assets reduces the size of the digital assets by ½ times the size of the digital assets as displayed on a display linked to the leader node.

14. The system of claim 9, further implementing actions comprising:
generating, by the server node and from the received data identifying the digital assets in the workspace, a reduced set of data by removing the data identifying the first digital assets; and
sending, from the server node to the follower node, the reduced set of data, wherein, the reduced set of data identifies digital assets in the workspace with locations mapping inside the mapped display coordinates of the display linked to the follower node and the reduced set of data does not include the first digital assets.

15. The system of claim 14, further implementing actions comprising:
receiving, at the server node, an update event from the follower node indicating a pan operation in response to an input received at the follower node, wherein the pan operation moves at least a portion of the digital assets on the display linked to the follower node;
generating, from the received data identifying the digital assets in the workspace, a second reduced set of data by removing data identifying digital assets moved outside of the mapped display coordinates of the display linked to the follower node and including one or more of the first digital assets that are inside of the coordinates of the display linked to the follower node as a result of the update event; and
sending, from the server node and to the follower node, the second reduced set of data, wherein, the second reduced set of data identifies digital assets in the workspace with locations mapping inside the mapped display coordinates of the display linked to the follower node and the second reduced set of data does not include one or more of the first digital assets that have locations outside mapped display coordinates of the display linked to the follower node as a result of the update event.

16. The system of claim 9, wherein the received data further includes toolbar data identifying a toolbar including user interface elements, the toolbar data further identifying a source location and a source dimension of the toolbar as displayed on the display linked the leader node, further implementing actions comprising:
determining a target location and a target dimension of the toolbar for display on the display linked to the follower node, wherein the target location maps inside the mapped display coordinates of the display linked to the follower node and the target location and the target dimension prevent overlap of the toolbar with digital assets displayed in the display linked to the follower node.

17. A non-transitory computer readable storage medium impressed with computer program instructions to send data identifying digital assets in a workspace, the instructions, when executed on a processor, implement operations, of a server node, comprising:
receiving, at a server node and from a leader node, data identifying digital assets in the workspace.
identifying, by the server node and from the received data, data identifying first digital assets from the digital assets, wherein the first digital assets have locations outside mapped display coordinates of a display linked to a follower node following the leader node; and
sending, to the follower node, the received data identifying the digital assets in the workspace and the data identifying the first digital assets,
wherein the data sent to the follower node allows display, on the display linked to the follower node, of only digital assets in the workspace with locations mapping inside the mapped display coordinates of the display linked to the follower node and prevents display of the first digital assets with locations outside mapped display coordinates of the display linked to the follower node.

18. The non-transitory computer readable storage medium of claim 17, wherein a size of a display linked to the leader node is at least four times larger than a size of the display linked to the follower node.

19. The non-transitory computer readable storage medium of claim 17, wherein the leader node is used by a leader participant presenting collaboration data to a follower participant using the follower node.

20. The non-transitory computer readable storage medium of claim 17, wherein the data sent to the follower node, allows a reduction in a size of the displayed digital assets, when displaying the digital assets on the display linked to the follower node.

21. The non-transitory computer readable storage medium of claim 20, wherein the reduction in the size of the digital assets reduces the size of the digital assets by ½ times the size of the digital assets as displayed on a display linked to the leader node.

22. The non-transitory computer readable storage medium of claim 17, wherein the operations further include:
generating, by the server node and from the received data identifying the digital assets in the workspace, a reduced set of data by removing the data identifying the first digital assets; and
sending, from the server node to the follower node, the reduced set of data, wherein, the reduced set of data identifies digital assets in the workspace with locations mapping inside the mapped display coordinates of the display linked to the follower node and the reduced set of data does not include the first digital assets.

23. The non-transitory computer readable storage medium of claim 22, wherein the operations further include:
receiving, at the server node, an update event from the follower node indicating a pan operation in response to an input received at the follower node, wherein the pan operation moves at least a portion of the digital assets on the display linked to the follower node;
generating, from the received data identifying the digital assets in the workspace, a second reduced set of data by removing data identifying digital assets moved outside of the mapped display coordinates of the display linked to the follower node and including one or more of the first digital assets that are inside of the coordinates of the display linked to the follower node as a result of the update event; and
sending, from the server node and to the follower node, the second reduced set of data, wherein, the second reduced set of data identifies digital assets in the workspace with locations mapping inside the mapped display coordinates of the display linked to the follower node and the second reduced set of data does not include one or more of the first digital assets that have locations outside mapped display coordinates of the display linked to the follower node as a result of the update event.

24. The non-transitory computer readable storage medium of claim 17, wherein the received data further includes toolbar data identifying a toolbar including user interface elements, the toolbar data further identifying a source location and a source dimension of the toolbar as displayed on the display linked the leader node, implementing the method further comprising:
determining a target location and a target dimension of the toolbar for display on the display linked to the follower node, wherein the target location maps inside the mapped display coordinates of the display linked to the follower node and the target location and the target dimension prevent overlap of the toolbar with digital assets displayed in the display linked to the follower node.

25. A method for receiving data identifying digital assets in a workspace, the method including:
receiving, at a follower node and from a server node, data identifying digital assets in the workspace;
identifying, by the follower node and from the received data, data identifying first digital assets from the digital assets, wherein the first digital assets have locations outside mapped display coordinates of a display linked to the follower node; and
displaying, on the display linked to the follower node, the digital assets in the workspace with locations mapping inside the mapped display coordinates of the display linked to the follower node and preventing display of the first identified digital assets with locations outside mapped display coordinates of the display linked to the follower node.
